(19) United States
(12) Patent Application Publication
(10) Pub. No.: US 2022/0379383 A1
(43) Pub. Date: Dec. 1, 2022

(54) MONITORING SYSTEM AND ADDITIVE MANUFACTURING SYSTEM

(71) Applicant: KABUSHIKI KAISHA TOSHIBA, Tokyo (JP)

(72) Inventors: Tetsuo SAKAI, Taito (JP); Yasutomo SHIOMI, Koza (JP)

(73) Assignee: KABUSHIKI KAISHA TOSHIBA, Tokyo (JP)

(21) Appl. No.: 17/664,723

(22) Filed: May 24, 2022

(30) Foreign Application Priority Data
May 28, 2021 (JP) 2021-089831

(51) Int. Cl. B22F 12/90; B22F 10/85; B22F 10/64; B22F 10/364; B22F 10/38

(52) U.S. Cl. CPC B22F 12/90; B22F 10/85; B22F 10/64; B22F 10/364; B22F 10/38; B33Y 10/00

(57) ABSTRACT

According to one embodiment, a monitoring system includes a collection device and a processing device. The collection device collects information of a solidified portion that is solidified in additive manufacturing. The additive manufacturing forms a plurality of layers by repeatedly melting and solidifying a metal powder. The processing device generates quality data of an existence or absence of a defect of the solidified portion by using the information to determine the existence or absence of the defect.

### CROSS-REFERENCE TO RELATED APPLICATIONS

This application is based upon and claims the benefit of priority from Japanese Patent Application No. 2021-089831, filed on May 28, 2021; the entire contents of which are incorporated herein by reference.

### FIELD

Embodiments described herein relate generally to a monitoring system and an additive manufacturing system.

### BACKGROUND

There is an additive manufacturing apparatus that manufactures an article by additive manufacturing. In additive manufacturing, layers are added one at a time by repeatedly melting and solidifying a metal powder. Technology that can more easily ascertain the quality of an article of additive manufacturing is desirable.

### BRIEF DESCRIPTION OF THE DRAWINGS

FIG. 1 is a schematic view illustrating an additive manufacturing system according to an embodiment;

FIG. 2 is a block diagram illustrating the configuration of a monitoring system according to the embodiment;

FIG. 3 is a block diagram illustrating a control system of an additive manufacturing apparatus;

FIG. 4 is a schematic view illustrating the appearance of the additive manufacturing;

FIG. 5 is a schematic view illustrating an image obtained by the imaging device;

FIGS. 6A and 6B are schematic views for describing imaging regions;

FIG. 7 is a flowchart illustrating an operation of the monitoring system according to the embodiment;

FIG. 8 is a block diagram illustrating the configuration of an additive manufacturing system according to the embodiment;

FIG. 9 is a flowchart illustrating an operation of the monitoring system according to the embodiment;

FIG. 10 is a flowchart illustrating an operation of the monitoring system according to the embodiment; and

FIG. 11 is a schematic view illustrating a hardware configuration.

### DETAILED DESCRIPTION

According to one embodiment, a monitoring system includes a collection device and a processing device. The collection device collects information of a solidified portion that is solidified in additive manufacturing. The additive manufacturing forms a plurality of layers by repeatedly melting and solidifying a metal powder. The processing device generates quality data of an existence or absence of a defect of the solidified portion by using the information to determine the existence or absence of the defect.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

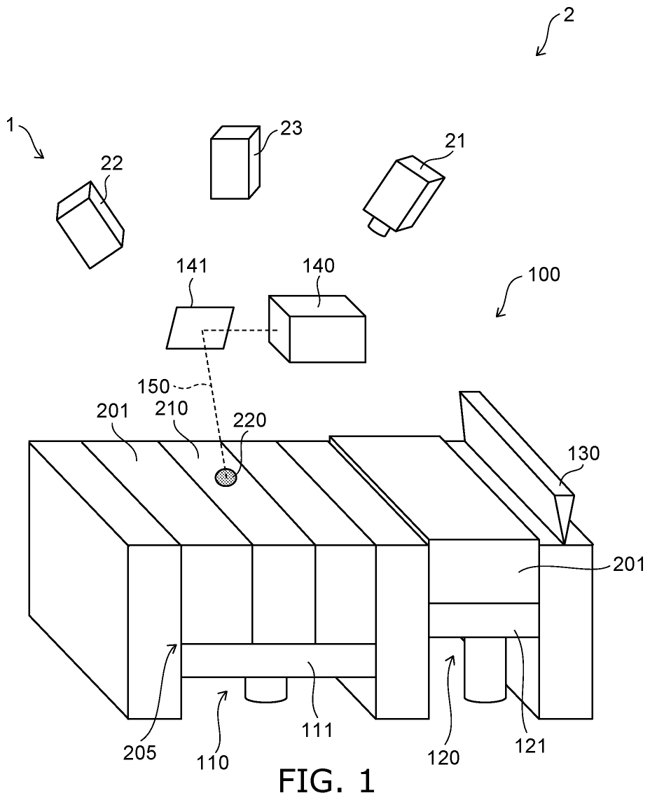

FIG. 1 is a schematic view illustrating an additive manufacturing system according to an embodiment.

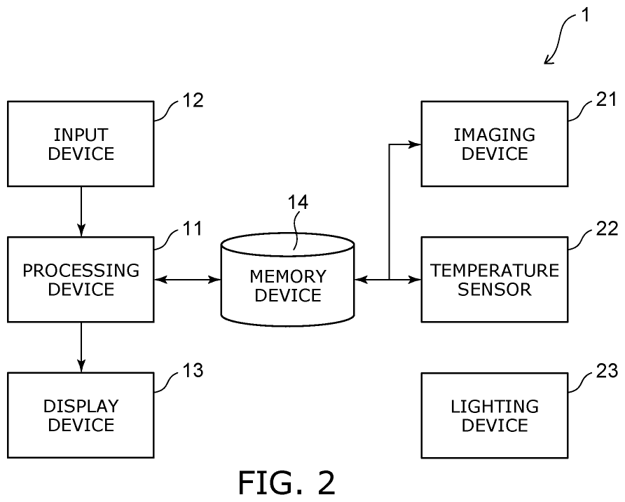

FIG. 2 is a block diagram illustrating the configuration of a monitoring system according to the embodiment.

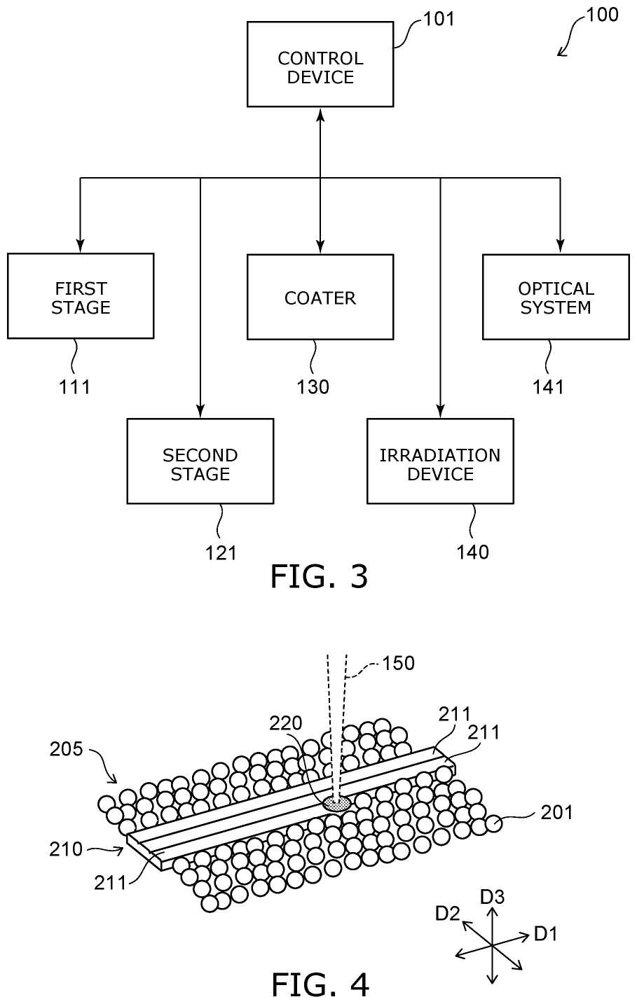

FIG. 3 is a block diagram illustrating a control system of an additive manufacturing apparatus.

As illustrated in FIG. 1, the additive manufacturing system includes the monitoring system 1 and the additive manufacturing apparatus 100.

As illustrated in FIG. 1, the additive manufacturing apparatus 100 includes a first container 110, a first stage 111, a second container 120, a second stage 121, a coater 130, an irradiation device 140, and an optical system 141.

A powder bed 205 on which a metal powder 201 is spread is located inside the first container 110. The additive manufacturing apparatus 100 partially melts the metal powder 201 located at the upper surface of the powder bed 205. The melted metal powder 201 solidifies to form a solidified layer. A solidified portion 210 is formed by repeatedly adding and bonded other solidified layers onto the solidified layer. Finally, an article that is made of the solidified portion 210 is manufactured.

The irradiation device 140 irradiates laser beam 150 on the metal powder 201 of the first container 110. The irradiation device 140 may emit an electron beam. The laser beam 150 is reflected by the optical system 141 and irradiated on a portion of the powder bed 205. The laser beam 150 is irradiated on any position of the powder bed 205 by driving the optical system 141.

The second container 120 stores the metal powder 201 to be supplied to the first container 110. The first stage 111 is located at the bottom portion of the first container 110. The second stage 121 is located at the bottom portion of the second container 120. The first stage 111 and the second stage 121 can be raised and lowered. The level of the upper surface of the powder bed 205 and the level of the upper surface of the solidified portion 210 are changed by raising or lowering the first stage 111. The level of the upper surface of the metal powder 201 stored in the second container 120 is changed by raising or lowering the second stage 121.

The first stage 111 is lowered after a new solidified layer of the solidified portion 210 is added by the laser beam 150 melting the metal powder 201. The upper surface of the powder bed 205 and the upper surface of the solidified portion 210 are positioned lower than the upper surface of the first container 110. Subsequently, the second stage 121 is raised. The upper surface of the metal powder 201 stored in the second container 120 is positioned higher than the upper surface of the second container 120. The coater 130 moves from the second container 120 toward the first container 110. The metal powder 201 that is positioned higher than the upper surface of the second container 120 is transported toward the first container 110 by the coater 130. A new layer of the metal powder 201 is supplied onto the powder bed 205 and the solidified portion 210 by the coater 130.

The monitoring system 1 collects information in additive manufacturing of the additive manufacturing apparatus 100. The monitoring system 1 uses the information to determine the existence or absence of a defect of the solidified portion 210. Also, the monitoring system 1 generates quality data of the existence or absence of the defect based on the determination result. As illustrated in FIG. 1, the monitoring system 1 includes an imaging device 21, a temperature sensor 22, and a lighting device 23.

The imaging device 21 is, for example, a camera that images the appearance of the first container 110 in the additive manufacturing. The imaging device 21 images the powder bed 205, the solidified portion 210, a weld pool 220 generated by the metal powder 201 melting, the laser beam 150 striking the powder bed 205 surface, etc. Thereby, the image of the appearance of the additive manufacturing is collected as the information.

The temperature sensor 22 measures the temperature of the powder bed 205, the solidified portion 210, or the weld pool 220. Thereby, the temperatures of the components in the additive manufacturing, the temperature distribution of the entirety, etc., are collected as the information. For example, the temperature sensor 22 measures the temperature of an object based on infrared radiated from the object.

The lighting device 23 illuminates the powder bed 205 so that the imaging device 21 can obtain a clearer image. An optical system for adjusting the imaging position of the imaging device 21 and the illumination position of the lighting device 23 may be included as appropriate.

FIG. 2 is a schematic view illustrating the configuration of the monitoring system according to the embodiment.

As illustrated in FIG. 2, the monitoring system 1 according to the embodiment further includes a processing device 11, an input device 12, a display device 13, and a memory device 14.

The processing device 11 generates quality data based on information collected by the imaging device 21 and the temperature sensor 22. The input device 12 is used when inputting data to the processing device 11. The display device 13 displays the data output from the processing device 11 toward a user. The memory device 14 stores the data. For example, the imaging device 21 and the temperature sensor 22 store the acquired information in the memory device 14. The processing device 11 acquires the information by accessing the memory device 14.

The operations of the imaging device 21, the temperature sensor 22, and the lighting device 23 may be controlled by the processing device 11 or may be controlled by another control device.

FIG. 3 is a schematic view illustrating a control system of the additive manufacturing apparatus.

For example, as illustrated in FIG. 3, the additive manufacturing apparatus 100 further includes a control device 101. The operations of the first stage 111, the second stage 121, the coater 130, the irradiation device 140, and the optical system 141 are controlled by the control device 101. The control device 101 refers to preset conditions of the additive manufacturing and operates the components according to the conditions.

FIG. 4 is a schematic view illustrating the appearance of the additive manufacturing.

In FIG. 4, the metal powder 201 is melted by irradiating the laser beam 150 as a heat source on a portion of the powder bed 205. The heat source may be an electron beam. The weld pool 220 is formed of the melted metal powder 201. The solidified portion 210 is formed by the melted metal powder 201 solidifying.

The solidified portion 210 includes multiple beads 211. The beads 211 extend along a first direction D1 along which the laser beam 150 is scanned. The multiple beads 211 are arranged in a second direction D2 that is perpendicular to the first direction D1.

When one or more beads 211 are formed for the metal powder 201 of one layer spreading along the first and second directions D1 and D2, a new layer of the metal powder 201 in a third direction D3 is supplied. The third direction D3 is perpendicular to the first and second directions D1 and D2. Other beads are formed in the new layer of the metal powder 201.

The imaging device 21 images the weld pool 220 and one or more beads 211 as the laser beam 150 is irradiated. The imaging device 21 may image the powder bed 205 before irradiating the laser beam 150. The imaging device 21 may image the powder bed 205 and the solidified portion 210 after irradiating the laser beam 150 and before supplying a new metal powder 201.

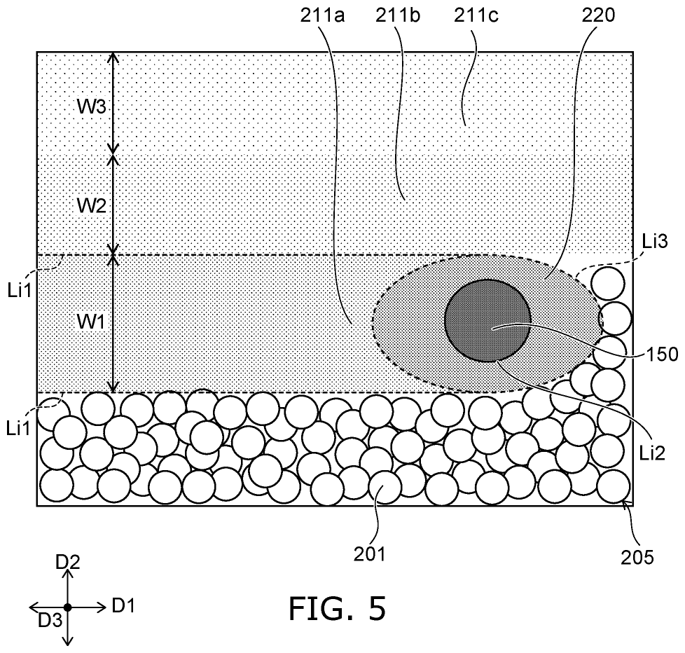

FIG. 5 is a schematic view illustrating an image obtained by the imaging device.

The laser beam 150, the metal powder 201, multiple beads 211a to 211c, and the weld pool 220 are imaged in the image (a first image) illustrated in FIG. 5. The bead 211b (a second bead) is formed before the bead 211a (a first bead). The bead 211c is formed before the bead 211b. The bead 211b is positioned between the beads 211a and 211c and is next to the beads 211a and 211c.

When receiving the image illustrated in FIG. 5, the processing device 11 extracts data used as features of the additive manufacturing from the image. For example, the processing device 11 extracts first data including at least one datum selected from the group consisting of a width W1 of the bead 211a directly after solidification, the contour of the bead 211a, the surface configuration of the bead 211a, a width W2 of the bead 211b, the contour of the bead 211b, the surface configuration of the bead 211b, a width W3 of the bead 211c, the contour of the bead 211c, the surface configuration of the bead 211c, the contour of the weld pool 220, and the size of the laser beam 150.

“Directly after solidification” refers to the bead 211 on the line along which the laser beam 150 was scanned. The bead 211 directly after solidification is arranged in the first direction D1 with the weld pool 220. The width of the bead 211a, 211b, or 211c corresponds to the length of the bead 211a, 211b, or 211c in the second direction D2. As the surface configuration, at least one selected from the group consisting of the size and the position of a local recess (a hole defect), the surface roughness, and the gloss (the luminance) may be used. The size of the laser beam 150 is represented by the surface area of the region surrounded with the contour of the laser beam 150.

The memory device 14 may store a first model for extracting the first data from the image. The first model includes, for example, a neural network. The processing device 11 inputs the image to the first model and acquires the first data output from the first model. For example, when the image illustrated in FIG. 5 is input, the first model outputs line segments Li1 to Li3. The line segments Li1 show the contour of the bead 211a and are the boundary line between the bead 211a and the metal powder 201 and the boundary line between the bead 211a and the bead 211b. The line segment Lit shows the contour of the laser beam 150. The line segment Li3 shows the contour of the weld pool 220.

When acquiring the first data, the processing device 11 refers to a database stored in the memory device 14. The database includes conditions for determining the existence or absence of the defect based on the first data.

As an example, the width of one of the beads 211 locally changes in a region in which a defect exists. A defect is determined to be included in a region when the width of the region is less than a preset threshold. As another example, a sufficient amount of the metal powder 201 may not be melted and a defect easily occurs when the size of the laser beam 150 is small. A defect is determined to be included in a region when the size of the laser beam 150 is less than a preset threshold.

For example, as the first data, the processing device 11 extracts multiple data including the contour of the bead 211a, the contour of the weld pool 220, and the size of the laser beam 150. The database includes conditions for the contour of the bead 211a, the contour of the weld pool 220, and the size of the laser beam 150. The processing device 11 determines the existence or absence of the defect by comparing the multiple data to the respective multiple conditions.

The database may include information related to the type of the defect. For example, the defect may be an undercut in which the solidified portion 210 is locally thin, an overlap in which the solidified portion 210 is locally thick, spatter that is formed when the melted metal scatters, etc. Multiple conditions that correspond to multiple types of defects are set for each datum. The processing device 11 determines the existence or absence of the defect and the type of the defect based on the multiple conditions included in the database.

The existence of the defect may be expressed as a probability. For example, one or more conditions is set for each datum. The probability that the defect exists is set for each condition. When the condition is satisfied, the defect is determined to exist with the set probability. The probability of the existence of the defect increases when multiple conditions are satisfied.

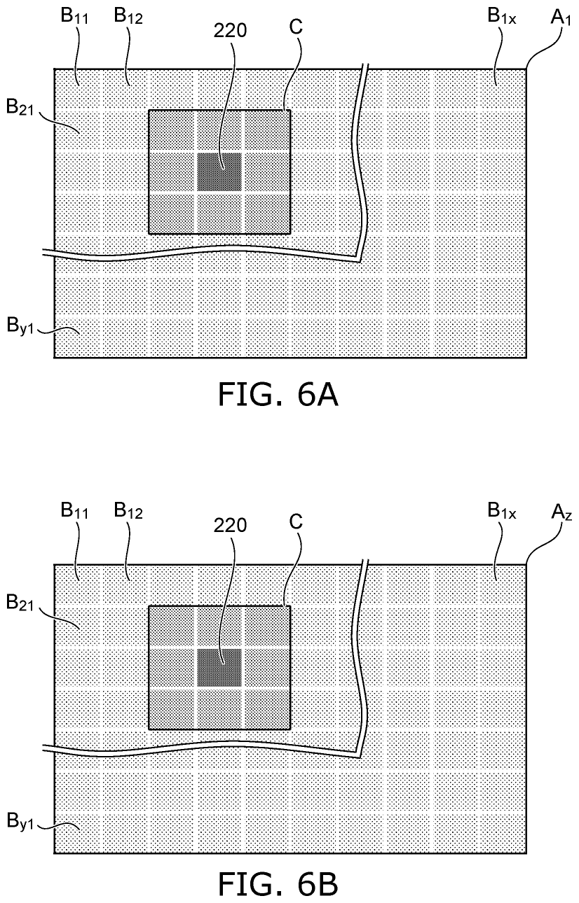

FIGS. 6A and 6B are schematic views for describing imaging regions.

FIG. 6A illustrates an initial layer A₁ of the metal powder 201 supplied to the first container 110. The layer A₁ includes multiple regions B₁₁ to B_{xy} in the first and second directions D1 and D2. In the illustrated example, x regions B are arranged in the first direction D1; and y regions B are arranged in the second direction D2. An area C that is imaged is set to be larger than one region B. The imaging device 21 images the laser beam 150, the solidified portion 210, and the weld pool 220 when the laser beam 150 is irradiated on each of the regions B₁₁ to B_{xy}. Thereby, x×y images are acquired for the layer A₁.

The imaging device 21 similarly repeats the imaging for each of the layers. For example, FIG. 6B illustrates a zth layer A_{z} supplied to the first container 110. Similarly to the layer A₁, the imaging device 21 images each of the regions B₁₁ to B_{xy} of the layer A_{z} when the laser beam 150 is irradiated.

The imaging device 21 acquires multiple images that have mutually-different imaging positions in the first direction D1, the second direction D2, or the third direction D3. The processing device 11 determines the existence or absence of the defect in the multiple imaging regions based on the multiple images.

The processing device 11 may determine the existence or absence of the defect based on the difference between the multiple images. Typically, the number of regions determined to include a defect is less than the number of regions determined not to include a defect. The difference is relatively small between images of regions determined not to include a defect. The difference is relatively large between the image of a region determined not to include a defect and the image of a region determined to include a defect.

For example, the processing device 11 inputs a new image and one or more previous images to the first model and acquires the line segments Li1 to Li3 corresponding to each image. The processing device 11 calculates the feature difference between the multiple images for the line segments Li1 to Li3. The processing device 11 determines the existence or absence of the defect in the region imaged in the new image by comparing the difference to a preset condition.

Or, a reference image when there is no defect may be prestored in the memory device 14. The processing device 11 calculates the difference between the new image and the reference image. The processing device 11 uses the difference to determine the existence or absence of the defect in the region imaged in the new image.

The processing device 11 may calculate the difference between images of the regions B of the layers A₁ to A_{z} at the same position in the first and second directions D1 and D2. For example, the processing device 11 calculates the differences between the image of the region B₁₁ of the layer A_{z} and each of the images of the regions B₁₁ of the layers A₁ to A_{z-1}.

For example, the processing device 11 calculates one or both of the luminance difference or the contrast value difference as the difference. The processing device 11 may perform the calculation of the difference by calculating the gradient of the contrast by differentiating adjacent pixel regions, quantitatively calculating the periodicity by Fourier transform, simply calculating the shading difference, etc. The pixel region is a region made of one or more pixels. A threshold is preset as a condition for the difference. The processing device 11 determines that the region in the new image includes a defect when the difference is greater than the threshold.

The imaging device 21 may acquire an image (a second image) by imaging the powder bed 205 after the new layer of the metal powder 201 is supplied and before the laser beam 150 is irradiated. For example, the processing device 11 calculates the position in the third direction D3 at each of multiple points of the powder bed 205 from the obtained image, and calculates the average position of the positions. “Point” means a portion of a “region”. The processing device 11 calculates the distance (the difference) between the average position and the position of each point. A condition (a threshold) for the distance is preset. When the distance is greater than the threshold, this indicates that the surface of the solidified portion 210 formed at the point is locally recessed or protruding. The solidified portion 210 that is directly under the point for which the distance is greater than the threshold is determined by the processing device 11 to include a defect. Also, the likelihood of a defect occurring is high when the metal powder 201 solidifies at a point at which the distance is greater than the threshold. Therefore, a defect may be considered to exist (occur) at the point at which the distance is greater than the threshold. The imaging device 21 may include a depth sensor to acquire the position in the third direction D3 with higher accuracy.

For example, the imaging device 21 images the powder bed 205 at multiple positions in the first and second directions D1 and D2. The processing device 11 obtains one overall image by arranging and linking the obtained images in the first and second directions D1 and D2. The processing device 11 calculates the distance between the average position and the position of each point in one overall image.

The imaging device 21 may acquire an image (a third image) by imaging the solidified portion 210 after the irradiation of the laser beam 150 and before a new layer of the metal powder 201 is supplied. For example, the processing device 11 obtains one overall image by linking images of the regions of the solidified portion 210. From the obtained image, the processing device 11 calculates the positions in the third direction D3 of the points of the solidified portion 210 and the average position of the positions. The processing device 11 calculates the distance (the difference) between the average position and the position of each point. A condition (a threshold) is preset for the distance. The processing device 11 determines a defect to exist at a point at which the distance is greater than the threshold.

The processing device 11 may detect spatter existing on the solidified portion 210 from the overall image. For example, a region in which the position in the third direction D3 is higher than the average position by a prescribed threshold is counted as spatter. The region at which spatter is detected is determined by the processing device 11 to be a region that includes a defect. The processing device 11 may determine a region in which spatter exists to be a region that includes a defect when more than a specified number of spatter exist inside a preset surface area. The likelihood of a defect occurring is high when the metal powder 201 solidifies in a region in which spatter exists. Therefore, a defect may be considered to exist (occur) in a region when the region is positioned on a region in which spatter exists.

Multiple imaging devices 21 may be included. For example, the imaging device 21 that images the region when irradiating the laser beam 150 and another imaging device 21 that images the powder bed 205 or the solidified portion 210 before or after irradiating the laser beam 150 may be included.

The temperature sensor 22 measures the temperature of each portion in the additive manufacturing. For example, the temperature sensor 22 measures the temperature of the bead 211a directly after solidification, the temperature of the bead 211b, the temperature of the bead 211c, or the temperature of the weld pool 220 illustrated in FIG. 5 and generates second data of the temperature.

When acquiring the second data, the processing device 11 refers to the database stored in the memory device 14. The database includes conditions for determining the existence or absence of the defect based on the second data. For example, the database includes conditions (thresholds) for the temperature of the bead 211a, the temperature of the bead 211b, the temperature of the bead 211c, and the temperature of the weld pool 220. The processing device 11 determines the existence or absence of the defect by comparing the multiple temperatures included in the second data to the respective multiple conditions. As an example, a defect is determined to be included when the temperature of the bead 211a directly after solidification or the temperature of the weld pool 220 is less than a threshold.

For example, when the temperature of one of the bead 211a, the bead 211b, or the bead 211c is less than the threshold, there is a possibility that a crack or thermal distortion may occur in the solidified portion 210 due to the temperature difference between the bead 211a, the bead 211b, and the bead 211c. Also, the formation density changes when the width of one of the beads changes. A large change of the formation density may cause a defect due to the occurrence of a welding defect or a void that causes a welding defect.

The database may include information related to types of defects. For example, multiple conditions that correspond to multiple types of defects are set for the temperatures of the bead 211a, the bead 211b, or the weld pool 220. The processing device 11 determines the existence or absence of the defect and the type of the defect based on the multiple conditions included in the database. The existence of the defect may be expressed as a probability. For example, multiple conditions are set for the respective multiple data. The probability of the existence of a defect is preset for each of the conditions. When a condition is satisfied, a defect is determined to exist with the set probability. The probability that a defect exists increases when multiple conditions are satisfied.

Similarly to the imaging device 21, the temperature sensor 22 tracks the irradiation of the laser beam 150 and measures the temperature at the regions of each layer. For example, the temperature sensor 22 measures the temperatures of the bead 211a, the bead 211b, and the weld pool 220 when the laser beam 150 is irradiated on each of the regions B₁₁ to B_{xy} illustrated in FIG. 6A.

The temperature sensor 22 may measure the temperature at the regions of the powder bed 205 after a new layer of the metal powder 201 is supplied and before the laser beam 150 is irradiated. For example, the processing device 11 generates the temperature distribution of the powder bed 205 from multiple measurement results. The processing device 11 calculates the average temperature, the fluctuation of the temperature, etc., from the temperature distribution. The processing device 11 determines the existence or absence of the defect by comparing the calculated values to preset conditions (thresholds).

The temperature sensor 22 may measure the temperature of each region after the irradiation of the laser beam 150 and before a new layer of the metal powder 201 is supplied. The processing device 11 generates the temperature distribution of the powder bed 205 and the solidified portion 210 from the multiple measurement results.

For example, when the temperature distribution is large, bias of the residual stress inside the layer, shape nonuniformity, etc., may occur. When the temperature distribution is not less than a preset threshold, the likelihood of a formation defect occurring in the layer and in the vertically adjacent layers is high. The processing device 11 determines that defects are included in the layer and in the adjacent layers.

The processing device 11 stores the determination result in the memory device 14. When a defect is determined to exist, the processing device 11 stores the position of the defect in the memory device 14. When a defect is determined to exist, the processing device 11 may associate the image used in the determination with the determination result and the defect position. For example, the quality data includes the determination result of the existence or absence of the defect, the position of the defect, and the image used in the determination of the existence of the defect for the article that is manufactured.

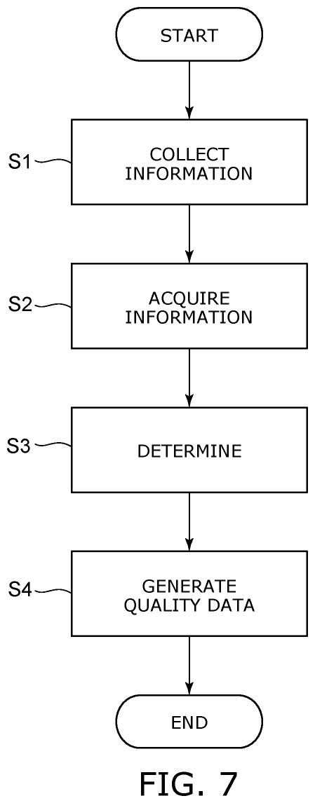

FIG. 7 is a flowchart illustrating an operation of the monitoring system according to the embodiment.

The collection device collects information in additive manufacturing (step S1). The processing device 11 acquires the collected information (step S2). The processing device 11 uses the information to determine the existence or absence of a defect at the positions at which the information is collected (step S3). In the determination, each datum that is included in the collected information is compared to a preset condition. The processing device 11 generates quality data of the existence or absence of the defect (step S4).

Advantages of the embodiment will now be described.

There are cases where a defect exists in an article manufactured by additive manufacturing. A defect of the article is, for example, a void. The existence or absence of the defect and the number of the defects have a relationship with the quality of the article. The quality is confirmed to be poor when a defect exists or the number of the defects is high. For example, the quality affects the price of the article, the application object of the article, etc. Or, articles of poor quality are excluded from business transactions. In other words, it is favorable to be able to ascertain the quality of the article that is manufactured to determine the price of the article, the application object, the possibility of business transactions, etc.

There is also a method in which a non-destructive inspection of the manufactured article is performed to check the existence or absence of the defect and the number of the defects. However, such a method requires time and expense for the inspection. Therefore, technology that can more easily ascertain the quality of the article is desirable.

According to the monitoring system 1 according to the embodiment, the collection device collects information in additive manufacturing. The collection device is the imaging device 21 or the temperature sensor 22. The processing device 11 uses the collected information to determine the existence or absence of defects. Also, the processing device 11 generates quality data that includes the determination result.

Because the information is collected in the additive manufacturing, it is unnecessary to provide a separate inspection process after manufacturing the article. Also, the user can ascertain the likelihood of a defect of the manufactured article by checking the quality data. For example, the user can ascertain the likelihood of the existence of a defect, the number of defects that may exist, etc. According to the embodiment, the quality of the article of the additive manufacturing can be more easily ascertained.

The monitoring system 1 according to the embodiment can be subsequently added to an already existing additive manufacturing apparatus 100. By adding the monitoring system 1 to an already existing additive manufacturing apparatus 100, the necessary expense can be reduced compared to when a new additive manufacturing apparatus with an embedded defect determination function is procured.

It is favorable for the quality data to include the positions of defects of the manufactured article. The user can easily ascertain the positions of the article at which defects may exist. It is favorable for the quality data also to include the images used in the determination of the defects. The user can easily check the sureness of the determination results of the processing device 11. The position of the defect may be marked in each image so that the user can easily ascertain the position of the defect inside the image.

Instead of a determination based on a preset condition, the processing device 11 may use a second model for determining the existence or absence of the defect. The second model includes, for example, a neural network. When acquiring the first data or the second data, the processing device 11 inputs the first data or the second data to the second model. The second model outputs data of the existence or absence of the defect. The processing device 11 acquires the output of the second model as the determination result. The second model is trained using multiple teaching data. The teaching data includes the first data, the second data, and labels for the data. The labels indicate the existence or absence of the defect and the type of the defect.

The processing device 11 may acquire a final determination result by combining the determination based on the preset condition and the determination of the second model. For example, when a defect is determined to exist based on the preset condition, the processing device 11 determines that the region includes a defect. The processing device 11 inputs the first data or the second data to the second model even when no defect is determined based on the preset condition. When the second model indicates the existence of a defect, the processing device 11 determines that the region includes a defect. By combining the second model, the existence of a defect that is difficult to determine using only the condition can be determined with higher accuracy.

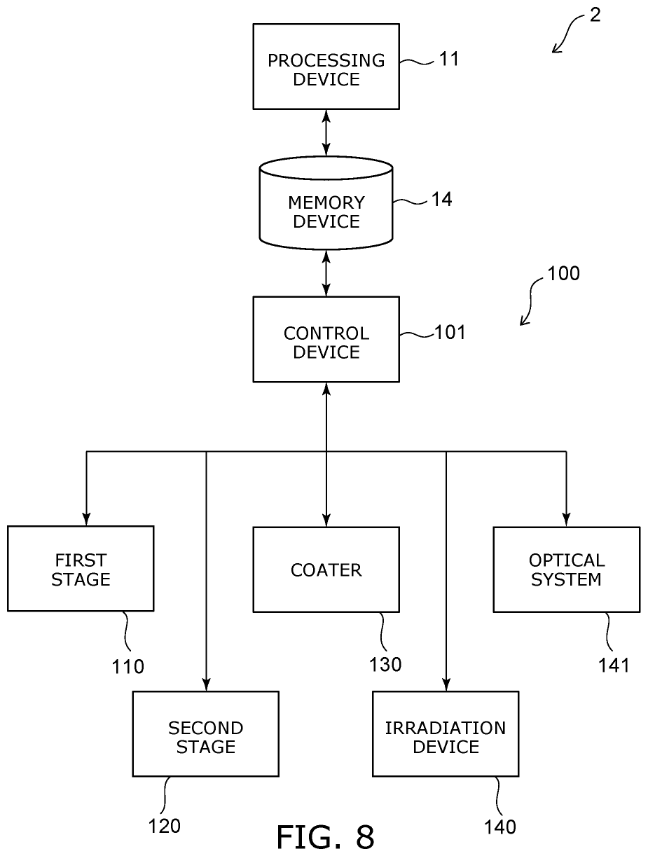

FIG. 8 is a block diagram illustrating the configuration of an additive manufacturing system according to the embodiment.

In the additive manufacturing system 2, the processing conditions of the additive manufacturing apparatus 100 may be modified according to the determination result of the monitoring system 1. Specifically, the processing device 11 modifies a processing condition of the additive manufacturing when a defect is determined to exist. The processing device 11 stores the modified processing condition in the memory device 14. The control device 101 controls the components of the additive manufacturing apparatus 100 according to the modified processing condition.

For example, a defect is determined to exist in the region of a portion of the bead 211. The processing condition is modified when irradiating the laser beam 150 on another region adjacent to the region. There is a possibility that the defect can be corrected thereby. As an example, when an undercut is determined to exist based on the first data, the irradiation time or the irradiation energy is increased when irradiating the laser beam 150 on the adjacent region. The undercut may be corrected thereby when a portion of the metal powder 201 melted in the other region flows into the undercut region.

The database includes information related to the processing conditions of the additive manufacturing. The database includes a correspondence between the processing conditions and values of the first data. When a defect is determined to exist, the processing device 11 accesses the database. The processing device 11 acquires the processing condition that corresponds to the first data used in the determination. The processing device 11 stores the acquired processing condition in the memory device 14. Thereby, the preset processing condition is modified to a processing condition for correcting the defect. The control device 101 controls the additive manufacturing apparatus 100 according to the modified processing condition.

The processing condition may be modified according to the type of the defect and the degree of the defect. For example, when the recess of the undercut is large, the irradiation time or the irradiation energy is further increased when irradiating the laser beam 150 on the other region. The amount of the melted metal powder 201 is increased thereby, and the molten metal easily flows into the undercut. The likelihood of correcting the defect can be increased.

The possibility of correction may be set for each type of the first data. When a defect is determined to exist, the processing device 11 accesses the database and refers to the possibility of correction for the first data used as the basis of the determination. When correction is possible, the processing device 11 acquires the modified processing condition for correcting the defect from the database. When correction is impossible, the processing device 11 does not modify the processing condition.

The additive manufacturing apparatus 100 may repeatedly manufacture the same article. The processing condition when manufacturing the next article may be modified based on the determination result of the manufacture of the previous article. For example, when manufacturing the next article, the processing device 11 modifies the processing condition at the position at which the defect was determined when manufacturing the previous article. The occurrence of a defect when manufacturing the next article is suppressed thereby.

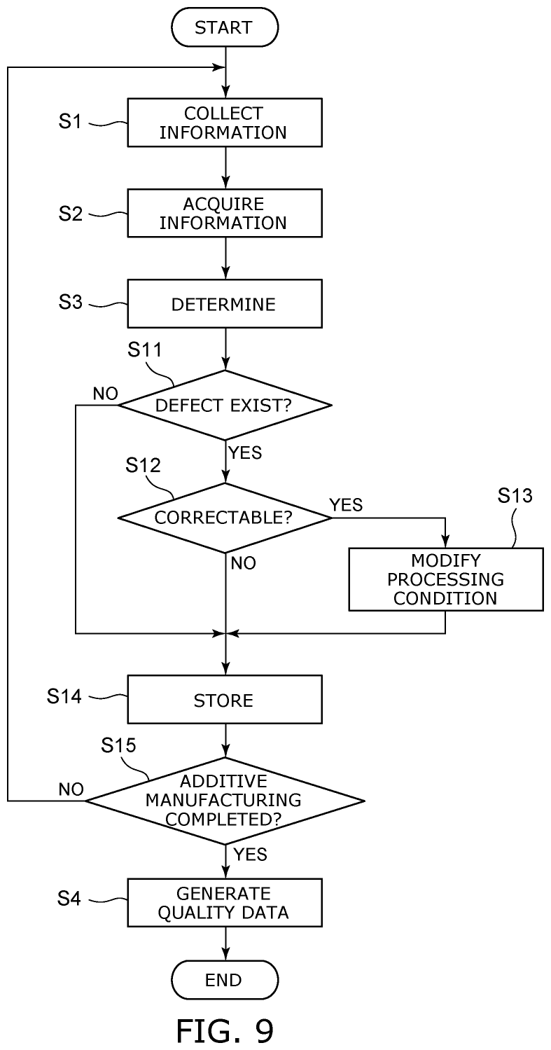

FIG. 9 is a flowchart illustrating an operation of the monitoring system according to the embodiment.

An operation of the monitoring system 1 when modifying the processing condition will now be described with reference to FIG. 9. Similarly to the flowchart illustrated in FIG. 7, the collection device collects information in additive manufacturing (step S1). The processing device 11 acquires the information (step S2) and determines the existence or absence of a defect (step S3). The processing device 11 determines whether or not the existence of a defect is determined (step S11). When the existence of a defect is determined, the processing device 11 refers to the database and determines whether or not the defect is correctable (step S12). When the defect is correctable, the processing device 11 modifies the processing condition (step S13). The defect that occurred may be corrected thereby. Or, the occurrence of the defect in the next article may be suppressed.

The processing device 11 stores the result in the memory device 14 (step S14) after the existence of a defect is not determined in step S11, after an uncorrectable defect is determined in step S12, or after step S13. Specifically, the processing device 11 stores the region in which the existence or absence of the defect was determined, the determination result, the possibility of correction of the defect, the modified processing condition, etc. The processing device 11 determines whether or not the additive manufacturing is completed (step S15). Step S1 is re-performed when not completed. Or, step S2 and subsequent steps may be performed after collecting the information of each region in the additive manufacturing. In such a case, steps S2 to S12 are repeated until the processing based on the information is completed. When the determination is completed for each region, the processing device 11 generates quality data (step S4).

The processing device 11 may determine the quality of the article based on the determination result of the regions. For example, the quality data further includes information related to the quality of the article.

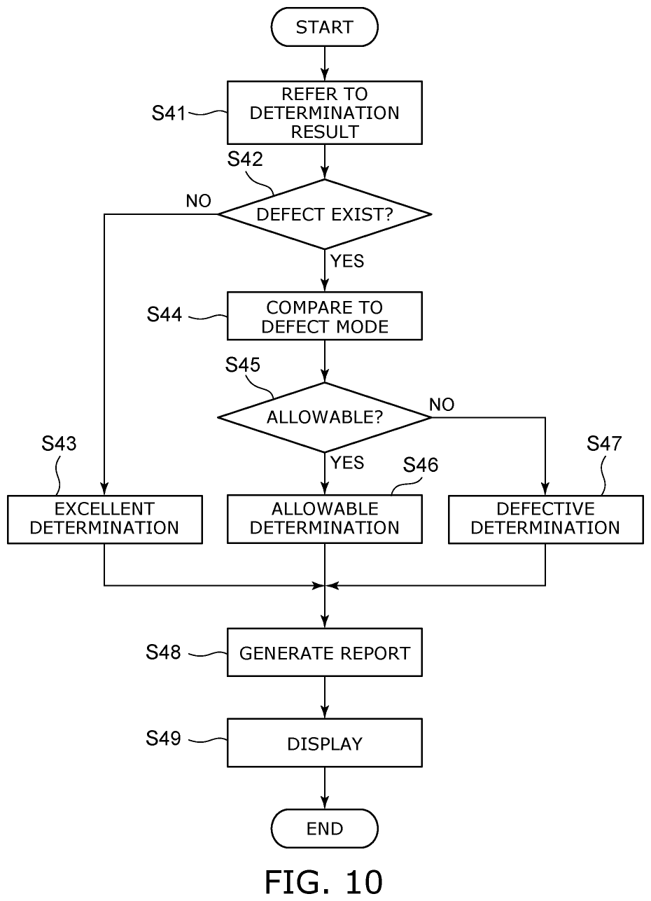

FIG. 10 is a flowchart illustrating an operation of the monitoring system according to the embodiment.

The processing device 11 may perform the processing illustrated in FIG. 10 in step S4 of the flowchart illustrated in FIG. 7 or FIG. 9. The processing device 11 accesses the memory device 14 and refers to the determination result of each region (step S41). The processing device 11 determines whether or not a defect is determined to exist in any of the regions (step S42). When the existence of a defect is not determined in any of the regions, the processing device 11 determines the quality of the article to be excellent (step S43).

For example, the database includes a correspondence between the defect mode and information related to the defect. When the defect is determined to exist in some region, the processing device 11 accesses the database and compares the information such as the number of defects, the position of the defect, the type of the defect, etc., to the defect mode (step S44). For example, the database includes data of whether or not the defect modes are allowable. The processing device 11 determines whether or not the obtained defect mode is allowable (step S45). When the defect mode is allowable, the processing device 11 determines the quality to be allowable (step S46). When the defect mode is not allowable, the processing device 11 determines the quality to be defective (step S47).

Excellent means superior to allowable. Allowable means superior to defective. Here, an example is described in which the quality is classified as three grades. The quality may be classified as four or more grades according to the existence or absence of the defect, the defect mode, etc.

The processing device 11 generates a report as the quality data (step S48). For example, the report includes the existence or absence of the defect, the number of defects, the type of the defect, the modified processing condition, the defect mode, and the image and quality of the region in which the defect is determined. The processing device 11 causes the display device 13 to display the report (step S49). Or, the processing device 11 may output the report in a prescribed file format such as Comma Separated Value (CSV), etc., and may write the report to a recording medium such as an SD card, etc. The processing device 11 may transmit the data to an external server using File Transfer Protocol (FTP) or the like or may insert the data into an external database server by performing database communication using Open Database Connectivity (ODBC), etc.

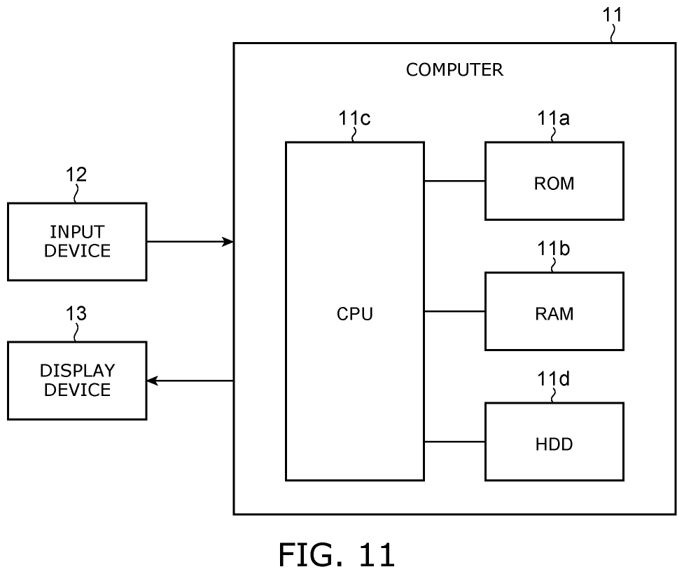

FIG. 11 is a schematic view illustrating a hardware configuration.

For example, the processing device 11 of the monitoring system 1 according to the embodiment is a computer and includes ROM (Read Only Memory) 11a, RAM (Random Access Memory) 11b, a CPU (Central Processing Unit) 11c, and a HDD (Hard Disk Drive) 11d.

The ROM 11a stores programs controlling the operations of the computer. The ROM 11a stores programs necessary for causing the computer to realize the processing described above.

The RAM 11b functions as a memory region where the programs stored in the ROM 11a are loaded. The CPU 11c includes a processing circuit. The CPU 11c reads a control program stored in the ROM 11a and controls the operation of the computer according to the control program. Also, the CPU 11c loads various data obtained by the operation of the computer into the RAM 11b. The HDD 11d stores data necessary for reading and data obtained in the reading process. For example, the HDD 11d functions as the memory device 14 illustrated in FIG. 2.

Instead of the HDD 11d, the processing device 11 may include an eMMC (embedded Multi Media Card), a SSD (Solid State Drive), a SSHD (Solid State Hybrid Drive), etc. The processing and functions of the processing device 11 may be realized by collaboration between more computers.

The input device 12 includes at least one of a mouse, a keyboard, or a touchpad. The display device 13 includes at least one of a monitor or a projector. A device such as a touch panel that functions as both the input device 12 and the display device 13 may be used.

According to the monitoring system, the processing device, or the monitoring method described above, the quality of an article of additive manufacturing can be more easily ascertained. Similar effects can be obtained by using a program for causing a computer to operate as the processing device.

The processing of the various data described above may be recorded in a magnetic disk (a flexible disk, a hard disk, etc.), an optical disk (CD-ROM, CD-R, CD-RW, DVD-ROM, DVD±R, DVD±RW, etc.), semiconductor memory, or another recording medium as a program that can be executed by a computer.

For example, the data that is recorded in the recording medium can be read by a computer (or an embedded system). The recording format (the storage format) of the recording medium is arbitrary. For example, the computer reads the program from the recording medium and causes a CPU to execute the instructions recited in the program based on the program. The acquisition (or the reading) of the program by the computer may be performed via a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. The above embodiments can be practiced in combination with each other.

What is claimed is:

1. A monitoring system, comprising:
a collection device collecting information of a solidified portion that is solidified in additive manufacturing, the additive manufacturing forming a plurality of layers by repeatedly melting and solidifying a metal powder; and
a processing device generating quality data of an existence or absence of a defect of the solidified portion by using the information to determine the existence or absence of the defect.

2. The monitoring system according to claim 1, wherein
the collection device includes an imaging device,
the information includes an image, and
the processing device determines the existence or absence of the defect of the solidified portion based on the image.

3. The monitoring system according to claim 2, wherein
the information includes a first image,
a first bead, a second bead, a weld pool, and a heat source are imaged in the first image,
the first bead and the second bead are included in the solidified portion,
the weld pool is imaged in a melted state,
the second bead is next to the first bead,
the processing device acquires first data from the first image,
the first data includes at least one datum selected from the group consisting of a width of the first bead directly after solidification, a contour of the first bead, a surface configuration of the first bead, a width of the second bead, a contour of the second bead, a surface configuration of the second bead, a contour of the weld pool, and a size of the heat source, and
the processing device determines the existence or absence of the defect of the solidified portion based on the first data.

4. The monitoring system according to claim 3, wherein
the processing device refers to a condition for the first data,
the condition is preset, and
the processing device determines the existence or absence of the defect by comparing the first data and the condition.

5. The monitoring system according to claim 3, wherein
the processing device acquires the first data by inputting the first image to a first model, and
the first model includes the contour of the first bead, the contour of the weld pool, and a contour of the heat source.

6. The monitoring system according to claim 3, wherein
the processing device extracts a difference between a plurality of the first images and determines the existence or absence of the defect of the solidified portion based on the difference.

7. The monitoring system according to claim 2, wherein
the information further includes a second image,
the second image is of a powder bed on which the metal powder is spread,
the second image is imaged after a new layer of the metal powder is supplied and before the metal powder is melted, and
the processing device acquires a surface configuration of the powder bed from the second image and determines the existence or absence of the defect of the solidified portion based on the surface configuration.

8. The monitoring system according to claim 2, wherein
the information further includes a third image of the solidified portion,
the third image is imaged after the metal powder has melted and solidified and before a new layer of the metal powder is supplied, and
the processing device acquires a surface configuration of the solidified portion from the third image and determines the existence or absence of the defect of the solidified portion based on the surface configuration.

9. The monitoring system according to claim 2, wherein
when the defect is determined to exist, the processing device adds the image used in the determination to the quality data.

10. The monitoring system according to claim 1, further comprising:
a lighting device illuminating the solidified portion.

11. The monitoring system according to claim 1, wherein
the collection device includes a temperature sensor,
the information includes second data including a temperature of a weld pool in a melted state and a temperature of the solidified portion, and
the processing device determines the existence or absence of the defect of the solidified portion based on the second data.

12. The monitoring system according to claim 1, wherein
the collection device collects the information of the solidified portion when forming each of the plurality of layers.

13. The monitoring system according to claim 1, wherein
the collection device collects a plurality of the information in the additive manufacturing,
the processing device determines the existence or absence of the defect in a plurality of regions of the solidified portion, and
the quality data includes the existence or absence of the defect and positions of the regions that include the defect.

14. The monitoring system according to claim 1, wherein
the processing device modifies a processing condition in the additive manufacturing based on a determination result of the existence or absence of the defect.

15. An additive manufacturing system, comprising:
the monitoring system according to claim 1; and
an additive manufacturing apparatus performing at least additive manufacturing.
